(19) United States
(12) Patent Application Publication
(10) Pub. No.: US 2006/0061000 A1
(43) Pub. Date: Mar. 23, 2006

(54) Method for manufacturing a two-color and two-hardness EVA foamed sole

(76) Inventors: Shih-Chien Chun, Chang Hua County (TW); Ting-Yu Lee, Chang Hua County (TW); Chen-Wei Huang, Chang Hua County (TW); Lung-Fa Wu, Chang Hua County (TW)

Correspondence Address: CHARLES E. BAXLEY, ESQ., 90 JOHN STREET, THIRD FLOOR, NEW YORK, NY, 10038, US

(21) Appl. No.: 10/947,471

(22) Filed: Sep. 22, 2004

(51) Int. Cl. B29C 44/12

(52) U.S. Cl. 264/45.4; 264/46.4

(57) ABSTRACT

A method for manufacturing a two-color and two hardness EVA foamed sole, comprises: preparing a first material: choosing a side block as the first material; loading a mold: putting the side block into a cavity of a mold, and the mold is not formed with a feeding channel; preparing a second material: choosing EVA compound pallets as a second material, and the EVA compound pallets will fully fill the cavity of the mold after foaming; loading and flattening the mold: loading the EVA compound pallets in the cavity of the mold, and then flattening the EVA compound pallets, so that the EVA compound pallets are evenly distributed in the cavity of the mold; foaming the EVA compound pallets: obtaining a sole having two colors and two hardness by foaming the EVA compound pallets in the mold under known conditions.

### BACKGROUND OF THE INVENTION

1. Field of the Invention

The present invention relates to a method for manufacturing a two-color and two-hardness EVA (Ethylene-Vinyl Acetate Copolymer) foamed sole, and more particularly to a method comprising the steps as: A. preparing a first material B. loading the mold C. preparing a second material D. loading and flattening the mold E. foaming process.

2. Description of the Prior Arts

To improve the shoe's outward appearance, most of the shoes sold on the market are designed to have a two-color and two-hardness sole, wherein a groove is predetermined on the sidewall of the sole. In the groove is adhered with a side block whose color and hardness are different from the sole, thus, the sole is possessed with two colors and two hardness. However, the problem is that the combining effect is not good. Since the sole and the side block are combined together through adhesive agent which is susceptible to deterioration after the sole is affected by the water and the sunshine repeatedly and alternatively, thus, the side block will disengage the sole.

TW Patent serial No. 87,113,457 provides a solution to this problem, according to which, the side block is put at a predetermined position into the shoe mold, and then choosing EVA material as a material of the sole and injecting the EVA material into the mold with plastic injection machine, thus the side block is enclosed by the EVA material. Finally, a two-color and two-hardness EVA foamed sole is obtained after foaming process. Through this way, the sole and the side block are combined together rigidly. However, this method still has some defects that need to be improved:

First, the equipment cost is high: before the foaming process, a plastic injection machine is required to inject the plastic into the cavity of the mold. The plastic injection machine is high-cost and needs to be maintained and some consumptive parts need to replace regularly, thus increasing the production cost.

Second, time-consuming and material-wasteful: during the plastic injection, a feeding channel needs to be formed on the mold for feeding the plastic into the cavity of the mold. During the foaming process, some plastic material will be left in the feeding channel. At this moment, if the mold is used to produce different colored soles, the leftover of the plastic material in feeding channel of the mold must be cleaned up; otherwise it will be mixed with the plastic material which is to be used in the next injection process. On the other hand, the leftover in the feeding channel cannot be used again and will be deserted. Whenever the color of the sole needs to be changed, the feeding channel must be cleaned. Thus, it is time-consuming and material-wasteful.

The present invention has arisen to mitigate and/or obviate the afore-described disadvantages.

### SUMMARY OF THE INVENTION

The primary objective of the present invention is to provide a method for manufacturing a two-color and two-hardness EVA foamed sole, which is capable of reducing the equipment cost.

The secondary objective of the present invention is to provide a method for manufacturing a two-color and two-hardness EVA foamed sole, which is capable of improving the production efficiency.

A method for manufacturing a two-color and two-hardness EVA foamed sole in accordance with the present invention comprises:

preparing a first material: choosing a side block as the first material;

loading a mold: putting the side block into a cavity of a mold, and the mold is not formed with a feeding channel;

preparing a second material: choosing EVA compound pallets as a second material, and the EVA compound pallets will fully fill the cavity of the mold after foaming;

loading and flattening the mold: loading the EVA compound pallets in the cavity of the mold, and then flattening the EVA compound pallets, so that the EVA compound pallets are evenly distributed in the cavity of the mold;

foaming the EVA compound pallets: obtaining a sole having two colors and two hardness by foaming the EVA compound pallets in the mold under known conditions.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a flow chart for showing a method for manufacturing a two-color and two-hardness EVA foamed sole in accordance with the present invention;

FIG. 2 is an operational view for showing the process for preparing the first material in accordance with the method of the present invention;

FIG. 3 is an operational view for showing the process for preparing the second material in accordance with the method of the present invention;

FIG. 4 is an operational view for showing the process for loading and flattening the mold in accordance with the method of the present invention;

FIG. 5 is an operational view for showing the foaming process in accordance with the method of the present invention;

FIG. 6 is a perspective view of sole which is produced according to the method of the present invention.

### DETAILED DESCRIPTION OF THE PREFERRED EMBODIMENT

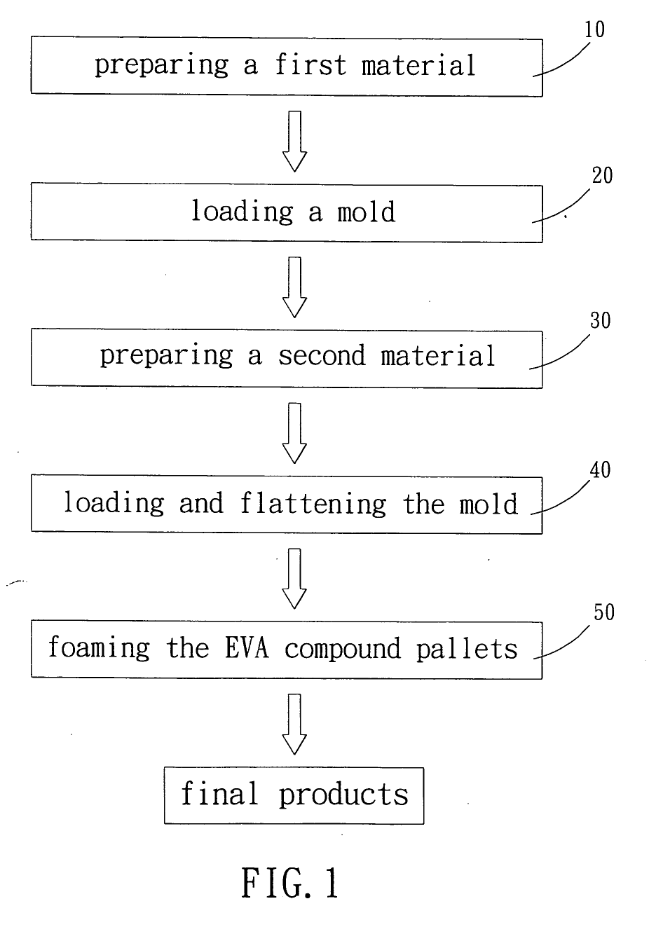

Referring to FIG. 1, which shows a method for manufacturing a two-color and two-hardness EVA foamed sole, and generally including the following steps: A. preparing a first material 10; B. loading the mold 20; C. preparing the second material 30; D. loading and flattening the mold 40; E. foaming process 50.

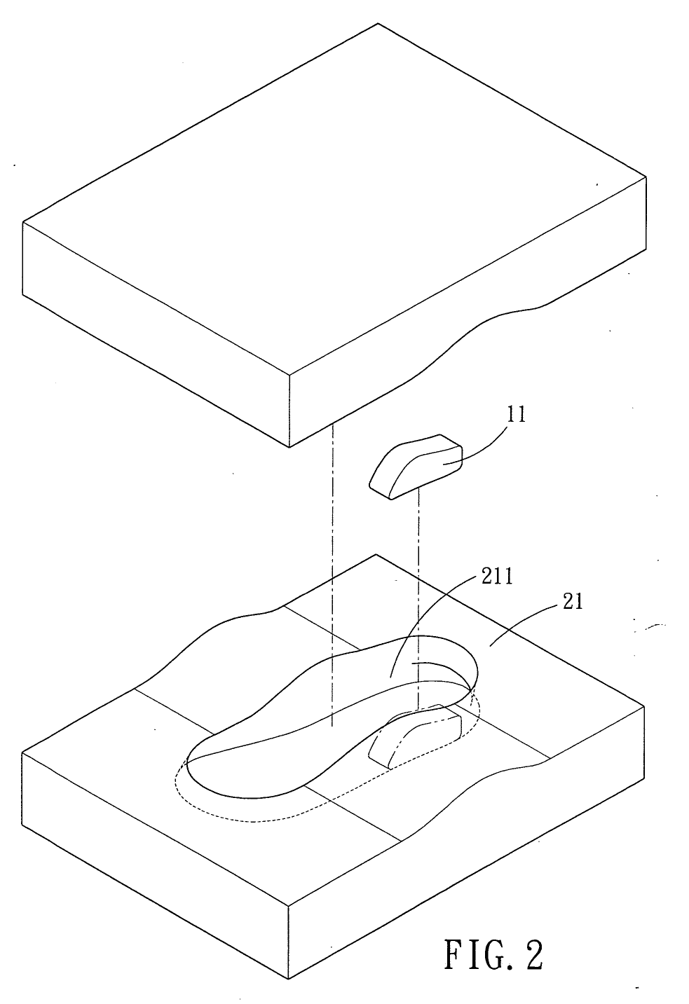

The process for preparing the first material 10: as shown in FIG. 2, is to choose a side block 11 as a first material, the hardness and the color of the side block 11 may be the same as or different from that of the sole, for example, the hardness may be the same while the colors are different, or the hardness may be different while the colors are the same. The side block 11 is harder than the sole.

The process for loading the mold 20: as shown in FIG. 2, is to put the side block 11 into the cavity 211 of the mold 21, and the mold 21 is not formed with a feeding channel, so that the cavity 211 will be absolutely closed after the mold 21 is closed.

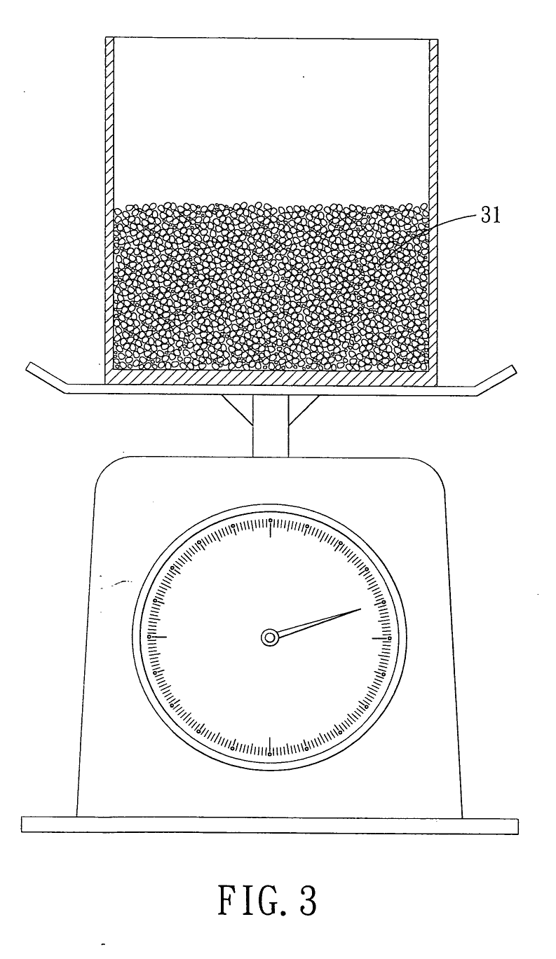

The process for preparing the second material 30: as shown in FIG. 3, is to choose a certain quantity of EVA compound pallets 31 as a second material, and the quantity of the EVA compound pallets 31 is calculated by transforming the cubage of the cavity 211 of the mold 21 into weight. Thus, the EVA compound pallets 31 will fully fill the cavity 211 of the mold 21 after foaming process.

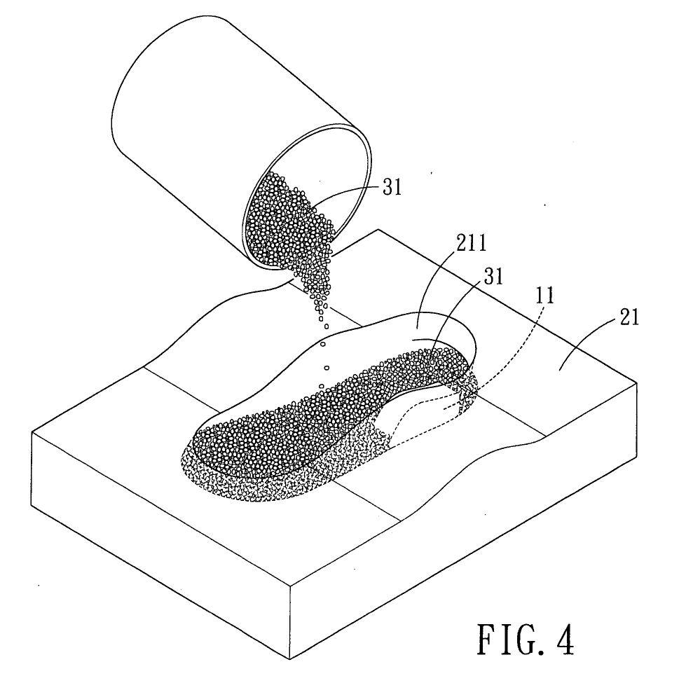

The process for loading and flattening the mold 40: as shown in FIG. 4, is to load the EVA compound pallets 31 in the cavity 211 of the mold 21, and then to flatten the EVA compound pallets 31 by using equipments, so that the EVA compound pallets 31 are evenly distributed in cavity 211 of the mold 21, and the side block 11 is partially covered by the EVA compound pallets 31.

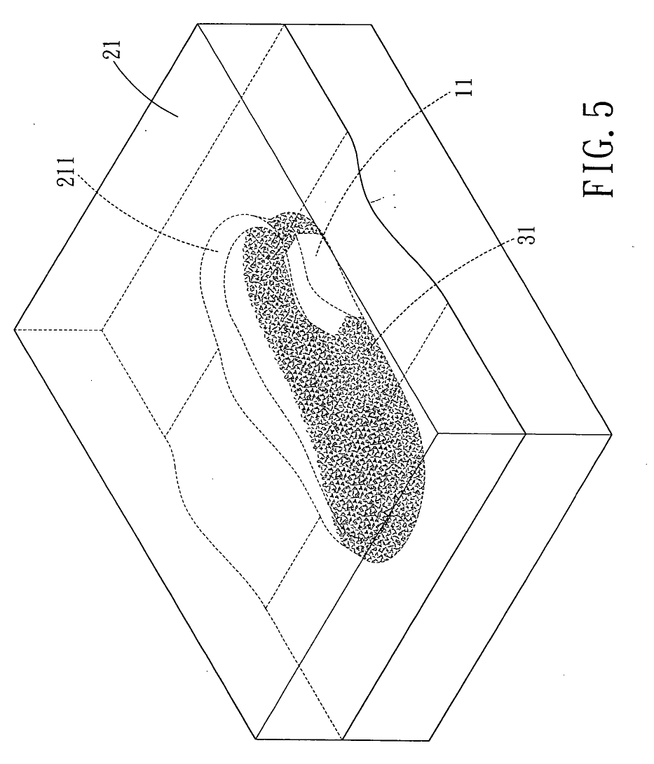

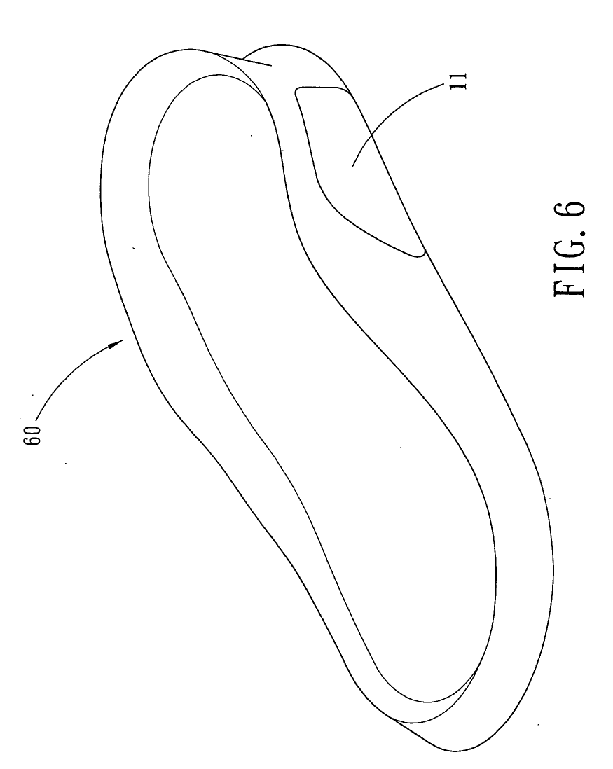

The process for foaming process 50, as shown in FIG. 5, is to close the mold 21, so that the cavity 211 is closed, and then foaming the EVA compound pallets 31 under known conditions. Thus, the foamed EVA compound pallets 31 fill the cavity 211 and enclose the side block 11. Finally, a sole 60 having two colors and two hardness is obtained after releasing the mold, as shown in FIG. 6.

As mentioned above that, besides having two colors and two hardness, the sole 60 of the present invention also can be more rigidly combined with the side block 11. Furthermore, the present invention also has the following advantages:

First, cost saving: before the foaming process, the producer can load the EVA compound pallets 31 into the cavity 211 of the mold 21 directly by manual operation. Thus, the cost for the plastic injection machine can be saved, and the maintenance fee is correspondingly saved, and as a result, the production cost is reduced too.

Second, labor-and-material saving: since the EVA compound pallets 31 are fed into the cavity 211 of the mold 21 directly, the mold 21 doesn't need to be formed with a feeding channel in communication with the cavity 211. Thus, no plastic wastes will be left in the feeding channel. Moreover, when the mold is used to produce different colored soles 60, no leftover of the plastic material in feeding channel of the mold needs to be cleaned up any more, thus saving the labor and improving the production efficiency.

Third, easy to change the color and having no effect on the production capacity: since the EVA compound pallets 31 are fed into the cavity 211 of the mold 21 directly, no large plastic injection machine needs to be used. During the course of changing the color, the producer can select and use the EVA- compound pallets 31 of desired color directly, thus, the operation process for changing the color is simplified. Unlike the conventional method that needs to clean up the plastic left in the injector of the plastic injection machine during the course of changing the color.

While we have shown and described various embodiments in accordance with the present invention, it should be clear to those skilled in the art that further embodiments may be made without departing from the scope of the present invention.

What is claimed is:

1. A method for manufacturing a two-color and two-hardness EVA (Ethylene-Vinyl Acetate Copolymer) foamed sole, comprising:
preparing a first material: choosing a side block as a first material;
loading a mold: putting the side block into a cavity of a mold, and the mold is not formed with a feeding channel;
preparing a second material: choosing EVA compound pallets as a second material, and the EVA compound pallets will fully fill the cavity of the mold after foaming;
loading and flattening the mold: loading the EVA compound pallets in the cavity of the mold, and then flattening the EVA compound pallets, so that the EVA compound pallets are evenly distributed in the cavity of the mold;
foaming the EVA compound pallets: obtaining a two-color and two hardness foamed sole by foaming the EVA compound pallets in the cavity of the mold under known conditions.

2. The method for manufacturing a two-color and two hardness EVA foamed sole as claimed in claim 1, wherein a quantity of the EVA compound pallets used in the process of preparing the second material is calculated by transforming the cubage of the cavity of the mold into weight.
